(19) United States
(12) Patent Application Publication
(10) Pub. No.: US 2023/0320315 A1
(43) Pub. Date: Oct. 12, 2023

(54) BIODEGRADABLE PACKING PRODUCT AND PET LITTER

(71) Applicants: Evelyn Cameron, Minnetonka, MN (US); Gavin Ferro, Minnetonka, MN (US); Lucian Pier, Minneapolis, MN (US)

(72) Inventors: Evelyn Cameron, Minnetonka, MN (US); Gavin Ferro, Minnetonka, MN (US); Lucian Pier, Minneapolis, MN (US)

(21) Appl. No.: 18/190,412

(22) Filed: Mar. 27, 2023

Related U.S. Application Data
(60) Provisional application No. 63/269,924, filed on Mar. 25, 2022.

(51) Int. Cl. A01K 1/015; B65D 81/36; B65D 65/46; B65D 81/09

(52) U.S. Cl. CPC A01K 1/0155; B65D 65/466; B65D 81/09; B65D 81/36

(57) ABSTRACT

A packing product is disclosed herein that includes pieces that each have a shape for absorbing impact. The shape can be an elbow-like shape, a v-shape, a u-shape, a helix shape, a tubular shape, an angled hollow tube, a coiled spiral, or some other shape configured to absorb impact in various versions. Each of the pieces can be formed by shaping a pulp comprising paper, sawdust, an antimicrobial agent, and water. The pieces are configured to maintain structure under pressure without snapping or breaking. The product can be used for packaging and shipping an item, then repurposed as a pet waste product, and finally for composting or recycling such as for use in gardening or lawn care.

### CROSS-REFERENCE TO RELATED APPLICATIONS

This application claims priority to U.S. Provisional Pat. Application No. 63/269,924, filed Mar. 25, 2022, the disclosure of which is hereby incorporated by reference in its entirety.

### TECHNICAL FIELD

The present disclosure generally relates to packing products and materials. More particularly embodiments of the present disclosure relate to packing products that are biodegradable and manufactured with suitable after-use properties as a pet litter or bedding.

### BACKGROUND

Packing peanuts and foam products are a common tool used to transport products that need to be protected in the shipping process. Packing materials come in various shapes, sizes, and compositions, but are not generally eco-friendly or easily disposed of. An additional tool to transport products includes polystyrene air pockets. These are made of plastic and filled with air, thus they are also not very eco-friendly.

Most packing peanuts are made of Styrofoam, which is a petroleum-based product. Foam products are an attractive option for packing materials because the foam can retain its shape and structure while maintaining a level of compressibility. However, there are many negative environmental implications due to the method used to extract petroleum to make such products. Further, petroleum-based products are not biodegradable and disposal typically involves landfilling or incineration of the materials after use.

In the interest of biodegradability and the use of recycled materials, paper products have been explored. While recycled paper has been used in packing materials, the products lack an after-use function. Existing sustainable packing peanut alternatives do not have well-established secondary uses and are therefore also typically sent to a landfill after use. Even paper packing materials may not be recyclable, as the paper used therein may not have adequate quality or fiber length to be recycled.

Packing materials composed of seaweed, corn starch, or fungi exist, but the cost of producing and purchasing these materials, and in particular seaweed packing materials, is commercially prohibitive at this time. While a seaweed packing product is biodegradable, it does not serve a second use or have a very long life-cycle. Once used, it must be recycled or disposed of.

An additional problem that exists is the extreme waste created by cat litter and animal bedding. Americans use over 217 million pounds of cat litter each month, approximately 40% of which is entirely clay-based. Clay is the product of mining and is not compostable. Most cat litter therefore must be incinerated or buried in landfills. Clay mining, which is the process used to create materials for cat litters, results in 1,041 million pounds of landfill or incineration waste annually. There are some identified eco-friendly cat litters and animal beddings, but each alternative is a single-use product that must be disposed of after use.

### SUMMARY

According to a first aspect described herein, a packing product includes a plurality of pieces each formed by the process of combining paper, sawdust, an antimicrobial agent, and water into a mixture. The process further includes forming and drying the mixture into a shape such as an elbowlike shape, a v-shape, a u-shape, a helix shape, a tubular shape, an angled hollow tube, a coiled spiral, and some other shape configured to absorb impact. The pieces are configured to maintain structure under pressure without snapping or breaking.

In some embodiments, the sawdust can be pine sawdust. The antimicrobial agent can be a bacteria or enzyme configured to neutralize a pet waste product. Each of the plurality of pieces can be hollow. The packing product can be free or substantially free of clay-based products. The packing product can include at least one of citrus, diluted lavender, dried lavender, ginger, and echinacea. The packing pieces can have a length of between about 0.75 inches long and about 1.5 inches long. The packing product can have a thickness from about 3 mm to about 5 mm.

In a second aspect, a method includes mixing ingredients including a paper pulp, sawdust, an antimicrobial additive, and water, blending the ingredients, forming the blended ingredients into a rectangle, rolling the rectangle around a straw to form a tubular structure, and cutting the tubular structure into a plurality of packing pieces. The method further includes using the packing pieces as a packing product for packaging and shipping an item, repurposing the packing product as a pet waste product, and composting or recycling the repurposed packing product for use in gardening or lawn care.

The method may further includes using pine sawdust as the sawdust. The packing pieces may be about 3 mm thick to about 5 mm thick. The antimicrobial agent may include beneficial bacteria or enzymes to neutralize animal feces or urine as the pet waste product. The method may further include using the repurposed packing product as a fertilizer. The mixture used to form the packing product may include: paper pulp in an amount from about 3.5% to about 15.9%, sawdust in an amount from about 0.6% to about 1.3%, an antimicrobial agent in an amount from about 0.1% to about 0.3% and water in an amount from about 84.4% to about 95.2%. Cutting can include creating a plurality of packing product pieces that are about 0.75 inches long, to about 1.25 inches long.

According to a third embodiment, a packing product includes a plurality of substantially tubular pieces formed by shaping and drying a mixture comprising paper, sawdust, and antimicrobial agent, and water. Each of the plurality of pieces has a first end and a second end, wherein the plurality of pieces each have a hollow interior. Each of the plurality of pieces has a raised lip on an exterior portion thereof, the raised lip extending from the first end to the second end and increasing a surface area to volume ratio of each of the plurality of pieces.

The packing product of claim 16 may include an antimicrobial agent. The pieces may have a thickness from about 3 mm to about 5 mm. The pieces may have a length of about 0.75 inches long to about 1.25 inches long. The mixture may further include diluted lavender, dried lavender, or citrus components to neutralize odor and absorb moisture.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of packing material inside of a box or shipping vessel, according to one embodiment.

FIG. 2 is a perspective view of a sheet of packing material during manufacturing, according to one embodiment.

FIG. 3 is a perspective view of a sheet of packing material being rolled into tubular packing 5 pieces, according to one embodiment.

FIG. 4 is an exploded view of tubular packing product pieces, according to one embodiment.

FIG. 5 is a flow-chart depicting the life-cycle of the packing product according to one embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

There is therefore a need for a packing product that is biodegradable, made of recycled materials, and capable of having an after-use function. There is also a need for a solution to cat litter waste and disposal. We have recognized that the solutions to these two problems complement one another. As described below, recycled materials can be converted into a product that is suitable for packaging (i.e., has impact-absorbing, space-filling properties) and also suitable for after-use as a pet waste litter or bedding. After use, the material can be composted or otherwise converted to raw organic material rather than being landfilled.

The present disclosure relates to a biodegradable packing product that is made of recycled materials. The packing product doubles as a product that is capable of being used a cat litter or as bedding for small animals or rodents. This means that the packing product may be used at least twice-first as a packing material, and then as an animal litter or bedding. Using the packing product for its secondary purpose eliminates the landfill waste associated with clay-based litters, and reduces or eliminates the waste generated by single-use packing materials. In some cases, the packing product may be used as packing material multiple times before being converted for its use as litter or bedding (referred to herein as “after-use”).

Packing materials and animal litters/bedding have many overlapping properties, but require additional features to facilitate both uses. Packing materials may be lightweight, cushioning, shock-absorbing, allergen free, and low in cost. Animal litters/bedding should absorb liquid, provide control odor, be allergen free, and also be low in cost. The addition of features such as pine sawdust to absorb odor may facilitate the overlap of the two uses.

In one embodiment of the packing product, the packing material may be formed into a tubular shape. The tube-shape of the packing material may help reduce overall materials and weight. The hollow nature of the packing material may aid in compressibility, while allowing for enough thickness to withstand weight and pressure from articles being shipped, which can crush or impinge on the packing product.

In another embodiment, the packing product may be a long cylinder shape, an angled hollow tube, a coiled spiral, or another shape that provides enough surface area and retention of shock-absorbing properties. The surface area of each piece of packing product may be important in after-use because it facilitates the absorption and release of moisture. The thickness of the packing product pieces may also be important because if it is too thick, the packing product will not be compressible. However, if it is too thin, it will not mechanically protect or insulate the products being packed and may crack or break.

In one embodiment, the packing product may be composed of a mixture of paper pulp, pine sawdust, an antibacterial additive, and water. The mixture may be blended, to achieve a desired consistency that permits spreading, drying, and forming as described in more detail below. The packing products components consist of items already in excess to reduce any additional waste. The overall consistency of the packing material may produce a product that is both firm and impact-absorbing to protect items being shipped, large enough to fill the volume of a box in relatively coarse pieces with gaps there between (i.e., more like packing peanuts than like sand) but small enough to be repurposed as cat litter or animal bedding, create minimal dust, absorb liquid (in the case that it is then used as cat litter or bedding), and absorb odor.

The absorption of odor may be achieved by use of the pine sawdust in the mixture produced to create the packing material. In another embodiment, citrus may be used to mask the odor. However, citrus has been found to have toxic effects on cats, but may be used for other animals. In yet another embodiment, lavender may be used to absorb or cover undesirable odors.

In one embodiment, the packing product may be made by blending the paper pulp, pine sawdust, an antibacterial additive, and water. Any method of combining the materials that creates a slurry or liquid consistency may be suitable. Once the mixture is combined, it may be rolled onto a surface into a flat sheet. The thickness of the sheet may be in the range from about 3 mm to about 5 mm. In additional embodiments, the thickness of the sheet may vary based on the weight of the items being shipped or packed. A thickness over 5 mm may produce too rigid of a sheet of material, providing challenges in rolling, and shaping the sheet of material. Different thicknesses may be appropriate depending on the friability, flexibility, crushability, or other rheological properties of the shape and material that make up the packing product.

The packing material can be crushed, ground, or blended to form a slurry or paste. That packing material can then be formed and dried into a packing product that is suitable for after-uses for animals. As an added benefit, with appropriate treatment and handling the final product can be composted or biodegraded.

After rolling the mixture into a sheet, it then may be wrapped around a straw or tube. The wrapping around the straw or tube creates the hollow structure of a packing product. The introduction of other fibrous materials (from reclaimed fabric, for example) allows the thickness to vary as it allows the shape to be formed with greater resistance to fractures.

Embodiments relate to a biodegradable packing product with after use capabilities and functions as a pet litter or bedding. The packing product is capable of two uses, first as packaging material and later as a pet litter or bedding product. The packing product provides adequate force dissipation or absorption to protect the contents of packages, and is also capable of absorbing liquid and masking odors such that it is usable as a pet litter. The composition is optionally selected so that after use as pet bedding or litter, it is compostable or biodegradable.

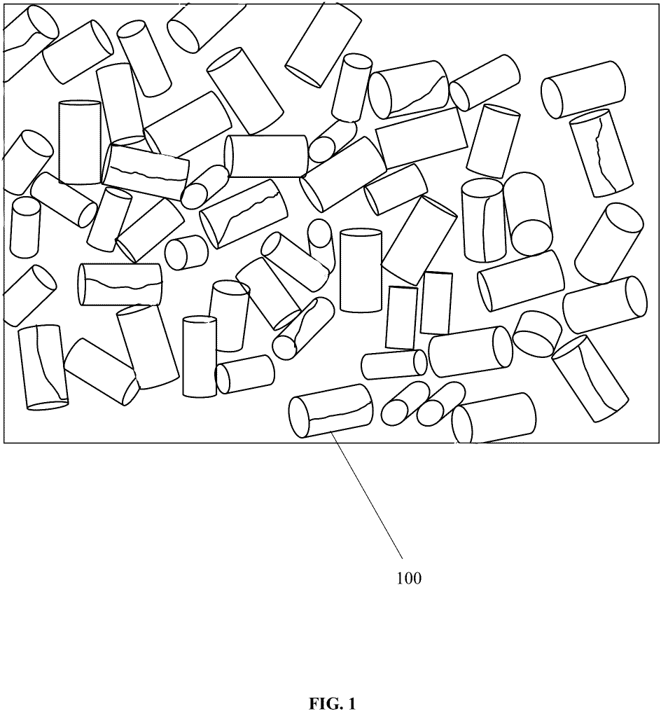

Referring to FIG. 1, an embodiment of the packing product 100 inside of a box or shipping vessel is shown. The packing product 100 functions similarly to a packing peanut or other package insulator, by being positioned or layered between the inside of a box and the contents thereof. The packing product 100 may be placed at the bottom of a box or shipping vessel, as well as above the object it is intended to insulate, to absorb impact and prevent damage.

The packing product 100 can have dimensions similar to those used in conventional packing products like packing peanuts. Typical packing peanuts come in “letter shapes.” For example, “S” shape peanuts are the most common shape for packing peanuts, and are small, curved peanut that looks like the letter S. “C” shape peanuts are similar to the S shape, but are more elongated and looks like a small, curved tube. “P” shape peanuts are shaped like the letter P and are often used for heavier items. “W” shape peanuts are wider and flatter than the other shapes, and are designed to create a more stable cushioning layer.

In addition to the letter-shaped designs, packing peanuts are also available in “Loose-fill” or “void-fill”: These are packing peanuts that come in irregular shapes and sizes. They are often used to fill in gaps and provide additional cushioning around items.

Each of these shapes can also be created using the packing material described herein, and formed into packing products in these shapes.

In terms of sizes, the packing product (like packing peanuts) can range from very small, about 3-4 mm in size, to much larger, up to 20 mm or more. The size and shape of the packing material will depend on the size and weight of intended articles to be packed, as well as the level of protection it requires during shipping or storage.

The design shown in FIG. 1 is roughly cylindrical and has a length of about 3-4 cm along its primary axis, with a diameter of about 0.5 to about 1.5 cm. However, it should be understood that alternative shapes and sizes could be used, such as those described above.

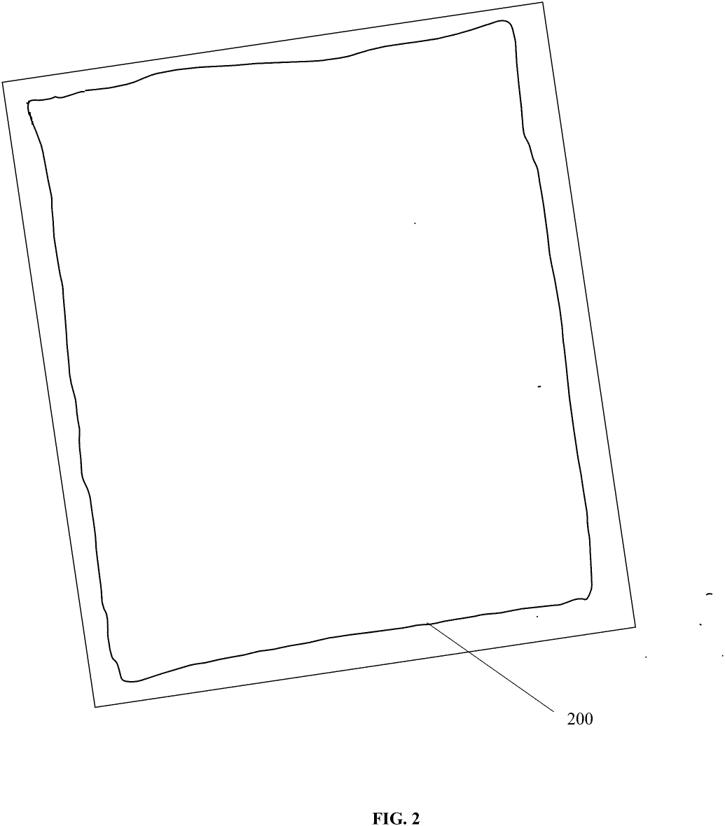

Referring to FIG. 2, an embodiment of a sheet of packing material is shown during the formation of the packing product of FIG. 1. The sheet of packing material 200 is used to created individual pieces that make up packing product 100. The sheet of packing material 200 is the product of blending the packing product 100 material, and rolling it into a desired thickness. The desired thickness may be a range of approximately 3-5 mm. The thickness may be important to the integrity of the packing product 100 pieces, because it allows the packing product 100 to withstand the weight of items being shipped and not break under the pressure. If the sheet of packing material 200 is too thick, the packing product 100 may not allow for enough cushion of the items in the box.

In alternative embodiments, different materials could have different associated thicknesses. For example, a material that is relatively more flexible or ductile could be made thicker since bending will not make it as susceptible to cracking during forming. A stronger material or one that is more densely packed with fibers from paper or cardboard could be thinner since it will not break as easily after drying and under mechanical impacts or stress.

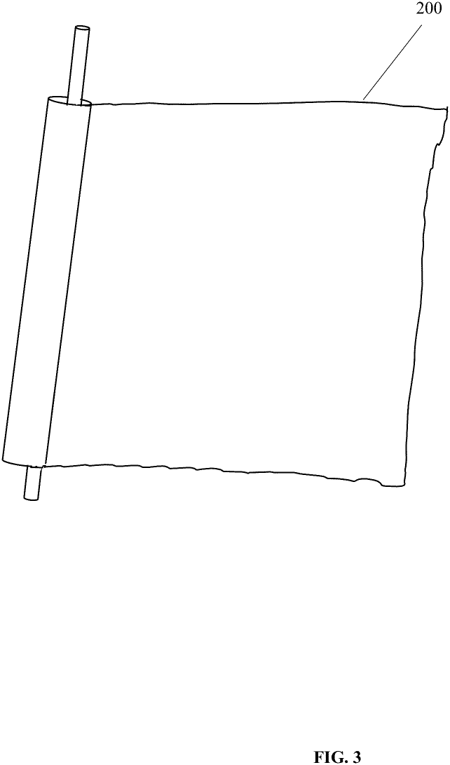

Referring to FIG. 3, an embodiment of a sheet of packing material being rolled into packing product 100 pieces is shown. Once the sheet of packing material 200 is rolled to a desired thickness, the packing product 100 pieces may be created. Each packing product 100 piece may be created by rolling the sheet of packing material around a straw or tubular structure. Once rolled, the sheet of packing material 200 is cut into individual pieces that may be approximately 0.75 to approximately 1.25 inches long.

In another embodiment, the individual pieces may be longer or shorter, depending on the shape and desired use. For example, smaller packing vessels may utilize longer packing pieces because less cushion is needed, whereas larger packing vessels may utilize shorter, and many individual packing pieces to create the most cushion in a vessel with more surface to cover. The individual pieces may be from about 3 to about 5 inches long, from about 5 to about 10 inches long.

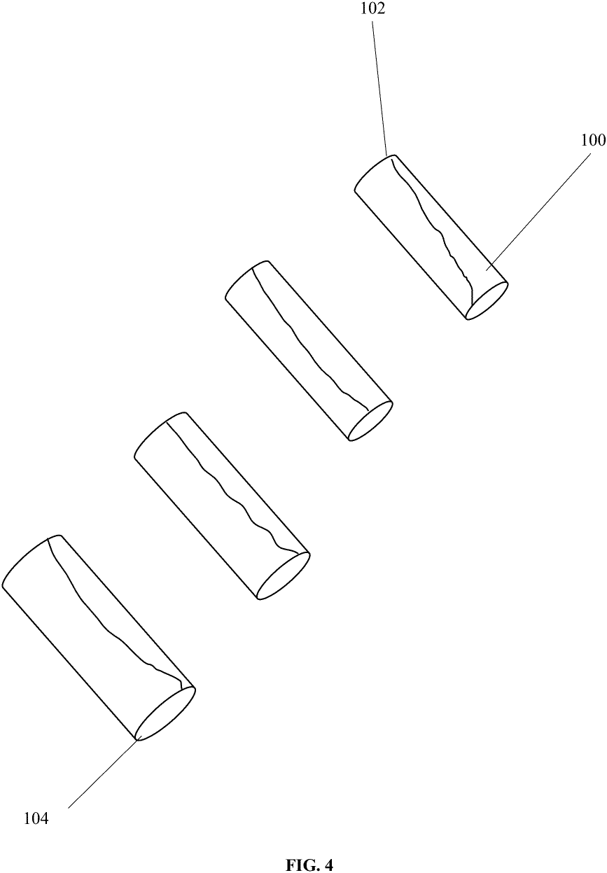

Referring to FIG. 4, four pieces of an embodiment of a packing product 100 are shown. Once the pieces of the packing product 100 are created, they may be layered in a box or shipping vessel. The packing product 100 may insulate items being shipped by creating a cushioned base, and also by covering the item being shipped.

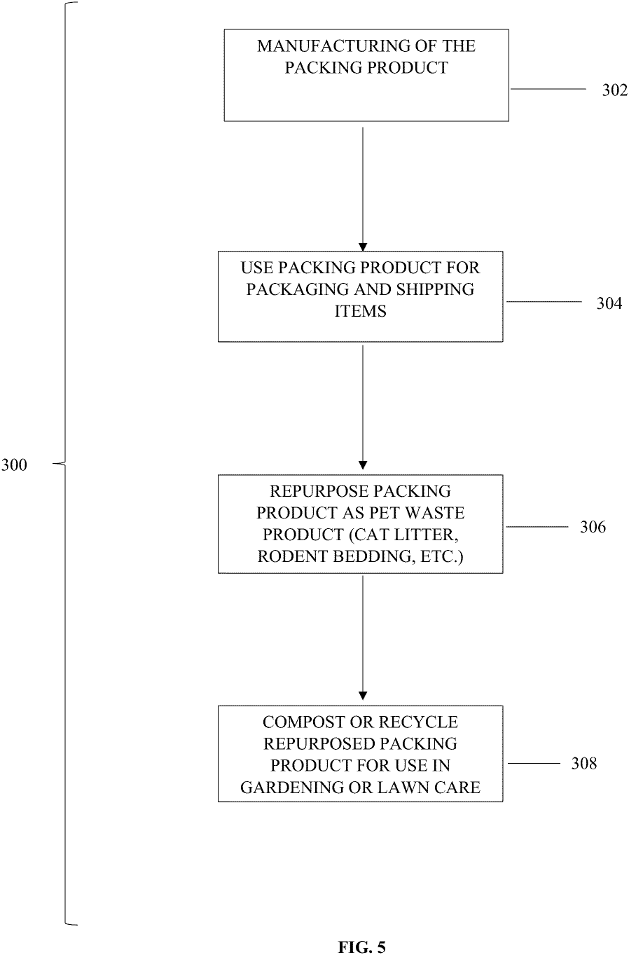

Referring to FIG. 5, an embodiment of a flow-chart illustrating a life-cycle of the packing product (e.g., packing product 100 of FIGS. 1-4). The life-cycle 300 of the packing product may be generally characterized by a few stages. First, the manufacturing of the packing product 302 takes place. Referring again to FIG. 3, the packing product may be made by blending the materials, rolling (or pouring) the mixing into the sheet of packing material (e.g., material 200), and rolling and cutting individual packing product pieces. It should be understood that rolling is just one method of making a shaped packing material, and that other shapes could be made by other mechanisms. For example, some shapes could be stamped, extruded, rolled, molded, or otherwise formed. The resulting shape should have the properties described above for use as a product packaging material: ability to absorb impact, such as by compressing, crushing, bending or flexing.

Once the packing product is created, it then may be used for packaging and shipping items 304. Next, the packing product may be repurposed for after-use as a pet waste product (cat litter, rodent/small animal bedding, etc.) 306. Because the packing product has a fully functional second-use, the lifecycle 300 adds a useful step before the product is composted or recycled. Finally, the packing product is composted for uses in gardening or lawn care, or recycled 308. In embodiments, however, the packaging product could be recycled without being used as litter.

Furthermore, the product could be transferred before such use; for example, a person may receive a package and therefore receive the material, but may not have a pet or want to use the product for their own pet, in which case the product could be delivered to a shelter, veterinary clinic, other pet owner, or other place where the product can be put to use as a litter.

### Shape

The packing product 100 may be tubular or substantially tubular in nature as described above. Once rolled, each packing product 100 piece may have a first end 102, and a second end 104. The packing product 100 may be hollow to allow for both cushion and flexibility in protecting items being shipped. The packing product 100 may be spiral-like, with a raised lip on the exterior from being rolled. In another embodiment, the packing product 100 may be any shape that facilitates a hollow interior. Additionally, the shape may have a relatively large surface area to volume ratio. Increased surface area of the packing product 100 piece may allow for increased absorption of moisture in the packing product 100 second use as a cat litter or 10 animal bedding. The increased surface area equally may allow for release of the moisture that has been absorbed.

Additional shapes of the packing product 100 may include an elbow-like shape, a v-shape, a u-shape, helix shaped, oval shaped, spherical, cube-shaped, rectangular, spiral-shaped, honeycomb shaped, half-moon shaped, triangular, crescent shaped, various cylindrical shapes, trapezoidal, different lengths or widths of tubular shapes, or any other shape that is hollow. The different shapes of the packing product 100 may allow for packing of heavier items, or longer usability for the second use as a cat litter or animal bedding. This may be because larger pieces of the packing product 100, may be able to cushion more mass, and in conjunction, absorb more liquid because they are larger.

In another embodiment, different shapes of the packing product 100 may still have a thickness in the range of from about 3 to about 5 mm to ensure that the packing product 100 is able to be compressed, but also maintain structure under pressure without snapping or breaking and to create the desired surface area to volume ratio.

### Material

The packing product 100 may be made of a material that includes paper pulp, pine sawdust, an antibacterial additive, and water. Additional additives could be used that are recycled, biodegradable, and would further improve on the properties established, such as the inclusion of fibrous materials. There are several ratios of the aforementioned materials that may be used to create a desired mixture. The below table illustrates some of the mixes that may yield a proper mixture. The examples disclosed in the table below are only possible mixtures that produce a proper consistency and viscosity for the uses disclosed herein. Additional ingredients may be added in various quantities and still produce a mixture suitable for the intended use.

| Mixes | Paper Pulp | Pine Sawdust | Antibacterial Additive | Water |
|---|---|---|---|---|
| A | ¼ Cup | 1 tsp. | ½ tsp. | 3 Cups |
| B | ¼ Cup | 2 tsps. | ½ tsp. | 3 Cups |
| C | ½ Cup | 2 tsps. | ½ tsp. | 3 Cups |
| D | ⅛ Cup | 1 tsp. | ¼ tsp. | 3 Cups |
| E | ¼ Cup | 2 tsps. | 0 | 3 Cups |

As shown in Table 1, then, the ratios between the mixes A-E are such that the paper pulp is present in an amount ranging from about 3.5% to about 15.9%, the sawdust is present in an amount from about 0.6% to about 1.3%, the antibacterial agent is present in an amount ranging from about 0.1% to about 0.3%, and water is present in an amount from about 84.4% to about 95.2%.

In another embodiment, the mixture may include citrus components (such as zest or juice), in place, or in addition to the pine sawdust for use in odor absorption. Citrus is known to have toxic effects on cats, however, it may be included in a mixture where the intended second use is for rodents or other small animals as a bedding/litter. Further, ginger or Echinacea are materials that may be used that are also safe for both cats and small rodents/mammals. Each material used may be a material that is already in excess, such as paper, to reduce further waste

In another embodiment, the antibacterial additive may neutralize animal feces or urine. The neutralizing may enable the use of the packing product 100 as compost or fertilizer to be used in a garden, in a similar fashion to the use of manure. In embodiments, the neutralizing or antimicrobial agent may include beneficial bacteria or enzymes.

In another embodiment, diluted lavender, or dried lavender, may be added in addition to the pine sawdust, or in place of the pine sawdust. Both the pine sawdust and lavender may serve the purpose of absorbing and masking odor for the packing product 100 second use as a cat litter or animal bedding. While pine sawdust may be used due to amply supply from attempts to divert lumberyard waste, in another embodiment other fibrous wood products such as bamboo, bamboo charcoal, or similar plant materials may be used.

### Manufacturing

The packing product 100 is manufactured using a series of steps. First, the desired mixture may be created by combining the ingredients mentioned above, including but not limited to: paper pulp, pine sawdust, an antibacterial additive, and water. Once the ingredients are added, they are blended or combined using a blender to create a slurry of desired consistency. After the mixture is created, it may be poured onto a screen or other surface, and dried. After drying, the sheet of packing material 200 may be cut into smaller rectangles, dampened to loosen the rigidity, and rolled around a mold.

The sheet of packing material 200 may be in the range of 3- 5 mm thick. Additional ranges of thickness may be advantages, depending on the shape of the individual pieces. However, widths thicker than 5 mm illustrated difficulty in being formed into the sheet of packing material 200, and further being rolled or formed around the straw. Additional ranges may include from about 0.5 to about 1 inch, and from about 1.5 to about 3 inches. Lower ranges of thickness may be used for packing items that are less heavy or dense, whereas thicker sheets of packing material may form individual pieces that accommodate more weight without being crushed.

The sheet of packing material 200 may then be rolled or formed around a straw, or similar tubular structure. Once rolled, the sheet of packing material 200 may be cut into individual packing product 100 pieces. The packing product 100 pieces may be in a range of .75-1.25 inches long.

Any number of methods or tools may be used to combine the above ingredients. Methods include, but are not limited to blending, use of a mortar and pestle, whisking, grinding, or any alternative that creates the desired mixture or consistency. Different methods of mixing may be used for the different options of mixes (A-E), or for the different desired shapes.

Additionally, the mixture may be extruded into various shapes disclosed herein, rather than rolling the mixture into the sheet of packing material, cutting it into rectangles, and rolling it around the straw or another substantially tubular toll prior to cutting the sheet of packing material into a plurality of pieces. The mixture may be pushed through, or extruded through a plate with pre-shaped holes. The pre-shaped holes may be any of the shapes disclosed herein, and still produce the plurality of pieces that are hollow in nature.

Extrusion techniques may be useful for creating larger quantities of the plurality of packing pieces at once, or when a variety of shapes are needed, rather than just one. Extrusion may also shorten the manufacturing process. Extrusion could be used to create a variety of cross-sectional shapes, including hollow tubes that are harder to form by rolling or other manipulations of a flat sheet.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Any incorporation by reference of documents above is limited such that no subject matter is incorporated that is contrary to the explicit disclosure herein.

Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A packing product comprising:
a plurality of pieces each formed by the process of combining paper, sawdust, an antimicrobial agent, and water into a mixture,
the process further comprising forming and drying the mixture into a shape selected from the group consisting of: an elbowlike shape, a v-shape, a u-shape, a helix shape, a tubular shape, an angled hollow tube, a coiled spiral, and some other shape configured to absorb impact;
wherein the plurality of pieces are configured to maintain structure under pressure without snapping or breaking.

2. The packing product of claim 1, wherein the sawdust is pine sawdust.

3. The packing product of claim 1, wherein the antimicrobial agent is a bacteria or enzyme configured to neutralize a pet waste product.

4. The packing product of claim 1, wherein each of the plurality of pieces are hollow.

5. The packing product of claim 1, wherein the packing product is free or substantially free of clay-based products.

6. The packing product of claim 1, further comprising at least one of citrus, diluted lavender, dried lavender, ginger, and echinacea.

7. The packing product of claim 1, wherein the plurality of packing pieces have a length of between about 0.75 inches long and about 1.5 inches long.

8. The packing product of claim 1, wherein the packing product has a thickness from about 3 mm to about 5 mm.

9. A method comprising:
mixing ingredients including a paper pulp, sawdust, an antimicrobial additive, and water, blending the ingredients,
forming the blended ingredients into a rectangle,
rolling the rectangle around a straw to form a tubular structure, and
cutting the tubular structure into a plurality of packing pieces;
using the packing pieces as a packing product for packaging and shipping an item;
repurposing the packing product as a pet waste product; and
composting or recycling the repurposed packing product for use in gardening or lawn care.

10. The method of claim 9, wherein the sawdust is a pine sawdust.

11. The method of claim 9, wherein the plurality of packing pieces are about 3 mm thick to about 5 mm thick.

12. The method of claim 9, wherein the antimicrobial agent includes beneficial bacteria or enzymes to neutralize animal feces or urine as the pet waste product.

13. The method of claim 9, further comprising using the repurposed packing product as a fertilizer.

14. The method of claim 9, wherein mixing the materials comprises forming a mixture in which:
paper pulp is added in an amount from about 3.5% to about 15.9%
sawdust is added in an amount from about 0.6% to about 1.3%
an antimicrobial agent is added in an amount from about 0.1% to about 0.3% and
water is added in an amount from about 84.4% to about 95.2%.

15. The method of claim 9, wherein the cutting includes creating a plurality of packing product pieces that are about 0.75 inches long, to about 1.25 inches long.

16. A packing product comprising:
a plurality of substantially tubular pieces formed by shaping and drying a mixture comprising paper, sawdust, and antimicrobial agent, and water;
each of the plurality of pieces having a first end and a second end, wherein the plurality of pieces each have a hollow interior; and
wherein each of the plurality of pieces has a raised lip on an exterior portion thereof, the raised lip extending from the first end to the second end and increasing a surface area to volume ratio of each of the plurality of pieces.

17. The packing product of claim 16, wherein the mixture comprises an antimicrobial agent.

18. The packing product of claim 16, wherein the plurality of pieces have a thickness from about 3 mm to about 5 mm.

19. The packing product of claim 16, wherein the plurality of pieces around from about 0.75 inches long, to about 1.25 inches long.

20. The packing product of claim 16, wherein the mixture further comprises diluted lavender, dried lavender, or citrus components to neutralize odor and absorb moisture.
